(19) United States
(12) Patent Application Publication
(10) Pub. No.: US 2013/0174748 A1
(43) Pub. Date: Jul. 11, 2013

(54) BUTTER MAKER

(71) Applicant: Dale Deel, Ocala, FL (US)

(72) Inventor: Dale Deel, Ocala, FL (US)

(21) Appl. No.: 13/346,035

(22) Filed: Jan. 9, 2012

(51) Int. Cl. A01J 15/04

(52) U.S. Cl. 99/452

(57) ABSTRACT

A butter making appliance adapted and configured for countertop operation includes a churning vessel having an open end through which cream may be introduced and butter may be withdrawn, the open end having a lid removably mountable thereto, the churning vessel being removably mountable to a motor-driven reciprocating drive housed within a housing, the drive being adapted and configured to drive the churning vessel in reciprocal motion, whereby the reciprocal motion of the churning vessel agitates cream contained therein causing it to convert to butter. Alternate embodiments include means for introducing at least one dwell period in each cycle of reciprocating motion to increase cream-to-butter conversion efficiency.

### FIELD OF THE INVENTION

The present invention technically relates to household appliances. More particularly, the present invention technically relates to kitchen appliances. Even more particularly, the present invention technically relates to butter makers.

### BACKGROUND OF THE INVENTION

The making of butter has been recorded as early as 2,000 years B.C. through the process of churning milk or cream. Unhomogenized milk and cream contain butterfat in microscopic globules (0.1-10 microns in diameter). These globules are surrounded by membranes made of phospholipids (fatty acid emulsifiers) and proteins, which prevent the fat in milk from pooling together into a single mass. Butter is produced by agitating (“churning”) cream, which damages these membranes and allows the milk fats to conjoin, separating from the other parts of the cream. As churning continues, larger clusters of fat collect until they begin to form a network with air bubbles that are generated by the churning; this traps the liquid and produces a foam. As the fat clumps increase in size, there are also fewer to enclose the air cells. So the bubbles pop, run together, and the foam begins to leak. This leakage is called buttermilk. The cream separates into butter and buttermilk. The buttermilk is drained off, and the remaining butter is kneaded to form a network of fat crystals that becomes the continuous phase, or dispersion medium, of a water-in-fat emulsion. Working the butter also creates its desired smoothness. Butter, therefore, is essentially the fat of the milk.

Although the exact mechanism by which butter is formed through churning is still uncertain, it is theorized that during the perturbation of the cream some air is incorporated into the liquid forming bubbles, and the fat globules collect in the bubble walls. The churned cream is warmed to the point that the globules soften and to some degree liquify. The ideal temperature range is said to be 55° to 65° F. (12° to 18° C.). Persistent agitation knocks the softened globules into each other enough to break through the protective membrane, and liquid fat cements the exposed droplets together. The foam structure is broken both by the free fat and the released membrane materials, which include emulsifiers like lecithin. These materials disrupt thin water layers and so burst bubble walls, and once enough of them have been freed in the process of whipping or churning cream, the foam will never be stable again. As churning continues, then, the foam gradually subsides, and the butter granules are worked together into larger and larger masses. Accordingly, butter is a water-in-fat emulsion resulting from an inversion of cream or milk, a fat-in-water emulsion.

Heretofore, a variety of methods and devices have been created to produce butter on a small scale (as opposed to on an industrial scale). Butter was first made by placing the cream in a container made from animal material and shaking until the milk has broken down in to butter. Later wood, glass, ceramic or metal containers were used. Butter churns have varied over time as technology and materials have changed. The first butter churns used a wooden container and a plunger to agitate the cream until butter formed. Referred to as a “plunge churn” or “dash churn” a stick called a dasher or churn dash was moved up and down by hand in an upright container, usually made of wood or earthenware. The stick might be perforated. or it could have a wooden circle, or crossed boards attached, but even with those to help beat the cream, this method took longer than using the more complex kinds of churn which were introduced in the 18th century, and became popular in the 19th.

Later butter churns used a container made from wood, ceramics or galvanized (zinc coated) iron that contained paddles. The hand-turned paddles were moved through the cream quickly, breaking the cream up by mixing it with air. This allows the butter to be made faster than by simply agitating the cream. Paddle churns were widely sold as small, convenient household churns in 19th century America, and glass ones were in use in the US in the 1940s.

A modern day example of a dash churn is described in U.S. Pat. No. 6,511,219 issued to Sevelle in 2003. The Sevelle patent teaches a compact butter maker that includes a cream container, a drive housing, a drive, and a dasher. The drive housing houses a drive, which is coupled to the dasher and adapted and configured to drive the dasher in reciprocal motion. The drive housing and the cream container are adapted and configured to reversibly mate and to position the dasher in the cream container for reciprocal motion within the container. The dasher and the container have complementary shapes with the dasher dimensioned to fit within the container and to define a space that can be occupied by cream within the container and around the dasher. Reciprocal motion of the dasher within the container converts the cream to butter. Although the Sevelle device is an improvement over butter makers of the past, it suffers from the same shortcomings and limitations of its ancestral dash churns, and close cousins, the paddle churns, namely it requires the use of an implement which must be cleaned after every use and it takes an unreasonable amount of time (by today's standards) to convert the cream into butter, namely 5 minutes. Moreover, the dashing component requires cleaning after use (like the fins and paddles of blenders and other rotary mixers).

Another apparatus developed for making butter was the barrel churn. Here, the whole churn would operate a crank turning paddles inside the barrel. Some were square in appearance, called box churns. Some barrel- and box-shaped churns were swung or rocked instead of turning. Churns of this sort were large, awkward, difficult to clean and took long periods of time to convert the cream into butter.

Centrifugal cream separators allow the properties of centrifuge to be applied to butter making. Instead of having spinning paddles, the paddles are fixed and the container spins. This allows better separation of the butter from the buttermilk and water. Such apparatus require transfer of the butter to a separate container for use after the butter is made, requiring the former to be cleaned, and also have a relatively large footprint as far as counter space is concerned.

In view of the above, it is apparent that a need exists for a kitchen countertop appliance for making home-made butter wherein the appliance has a small footprint relative to butter makers of the prior art, wherein the cream is transformed into butter in a shorter time period than heretofore possible with most if not all existing countertop devices, and wherein the apparatus does not require the use of fins, paddles, impellers, dashers or other such implements inside the churning vessel.

All patents, patent applications, provisional applications, and publications referred to or cited herein, or from which a claim for benefit of priority has been made, are incorporated herein by reference in their entirety to the extent they are not inconsistent with the explicit teachings of this specification.

### SUMMARY OF THE INVENTION

The subject invention more specifically relates to a butter making appliance adapted and configured for countertop operation comprising: a churning vessel having an open end through which cream may be introduced and butter may be withdrawn, the open end having a lid removably mountable thereto, the churning vessel being removably mountable to a motor-driven reciprocating drive housed within a housing, the drive being adapted and configured to drive the churning vessel in reciprocal motion, whereby the reciprocal motion of the churning vessel agitates cream contained therein causing it to convert to butter. The appliance further includes a safety cover removably mounted to the housing for enclosing the churning vessel therein. In a preferred embodiment, the drive is operable only when the safety lid is mounted to the housing, and the reciprocating drive is comprised of a piston slidably mounted within a cylinder bore of a cylinder, the cylinder being mounted within the housing or integrally formed therewith, a connecting rod having a first end and a second end, the first end being pivotally mounted to a piston, the second end being pivotally mounted to a crank throw of a rotatable crankshaft, the crankshaft being in operable engagement with the rotary shaft of a motor, whereby the crankshaft translates rotary motion of the motor shaft into reciprocating linear piston motion.

In an alternate embodiment, the second end of the second end of the connecting rod is fixedly mounted to a yoke having a linear slot perpendicular to the axis of reciprocating linear motion and in slidable engagement with a crank pin rotatably mounted to the crank throw, whereby the yoke, crank pin and crank throw convert the rotational motion of said crank shaft into reciprocating linear motion of the piston for agitation of cream charged to the churning vessel causing the cream to transform into butter more efficiently. In yet another embodiment, the slot of the yoke includes at least one centrally disposed radiused portion selected from the group consisting of a concave radius and a convex radius for imparting at least one dwell in each piston stroke cycle of the reciprocating linear motion, whereby cream contained within the churning vessel is caused to momentarily collect in at least one end of said churning vessel during the at least one dwell period and thereafter be abruptly cast against the opposite end of the churning vessel. Inclusion of at least one dwell in the piston stroke cycle further improves cream-to-butter conversion efficiency.

There has thus been outlined, rather broadly, the more important features of the invention in order that the detailed description thereof that follows may be better understood, and in order that the present contribution to the art may be better appreciated.

There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a butter maker that is compact in size and therefore suitable for countertop use in home kitchens and restaurants.

It is another primary object of the subject invention to provide a compact butter making appliance capable of converting cream into butter in under 30 seconds.

Another object of the subject invention is to provide a compact butter making appliance which does not require the insertion of baffles, paddles, dashes or any other object into the mixing vessel in order to convert the cream into butter.

Another object of the subject invention is to provide a compact butter making appliance designed to rapidly convert cream into butter when placed in a churning vessel that is subject to linear reciprocal movement.

Another object of the subject invention is to provide a compact butter making appliance capable of cooperative union with conventional Mason jars which can serve as the churning vessel.

It is also an object of the subject invention to provide a compact butter making appliance wherein all parts, both static and operable, are secured within a protective housing and lid.

Another object of the subject invention is to provide a compact butter making appliance that is fabricated from materials that are durable, corrosion-resistant, and non-absorbent.

Another object of the subject invention is to provide a compact butter making appliance that is fabricated from materials that are sufficient in weight and thickness to withstand repeated warewashing.

Another object of the subject invention is to provide a compact butter making appliance that is fabricated from materials that may be finished to possess a smooth, easily cleanable surface.

Still another object of the subject invention is to provide a compact butter making appliance that is fabricated from materials that are resistant to pitting, chipping, crazing, scratching, scoring, distortion and decomposition.

It is also an object of the subject invention is to provide a compact butter making appliance that is constructed to be free of breaks, open seams, cracks, chips, inclusions, pits, and similar imperfections.

Still another object of the subject invention is to provide a compact butter making appliance that is free of sharp internal angles, corners, and crevices which could retain moisture, bacteria, molds and other deleterious substances.

Yet another object of the subject invention is to provide a compact butter making appliance which is relatively simple in design and therefore capable of rapid construction at relatively low costs.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description

FIG. 1 is a front elevational view of the subject compact butter making appliance, portions of which are depicted in phantom view, and with the piston at the apex of an upstroke;

FIG. 2 is front elevational view of the appliance of FIG. 1 with the piston at the apex of a downstroke;

FIG. 3 is a side elevational view of the appliance of FIG. 1 illustrating an example motor and gear arrangement of the subject apparatus;

FIG. 4 is a front elevational view of an alternate reciprocating drive assembly including a Scotch yoke;

FIG. 5 is a front elevational view of a Scotch yoke modified to produce a dwell at one end of each piston stroke;

FIG. 6 is a graph illustrating the stroke cycle with a single dwell produced by the Scotch yoke of FIG. 6; and

FIG. 7 is a front elevational view of a Scotch yoke modified to produce a dwell at both ends of each piston stroke.

### DETAILED DESCRIPTION OF THE PREFERRED EMBODIMENT

At the outset, it should be clearly understood that like reference numerals are intended to identify the same structural elements, portions or surfaces consistently throughout the several drawings figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. Components are not drawn to scale or proportion. As used in the following description, the terms “horizontal” and “vertical” simply refer to the orientation of an object relative to level ground, and the terms “left”, “right”, “top” and “bottom”, “up” and “clown”, as well as adjectival and adverbial derivatives thereof (e.g., “rightwardly”, “upwardly”, etc.), simply refer to the orientation of a surface relative to its axis of elongation, or axis of rotation as appropriate.

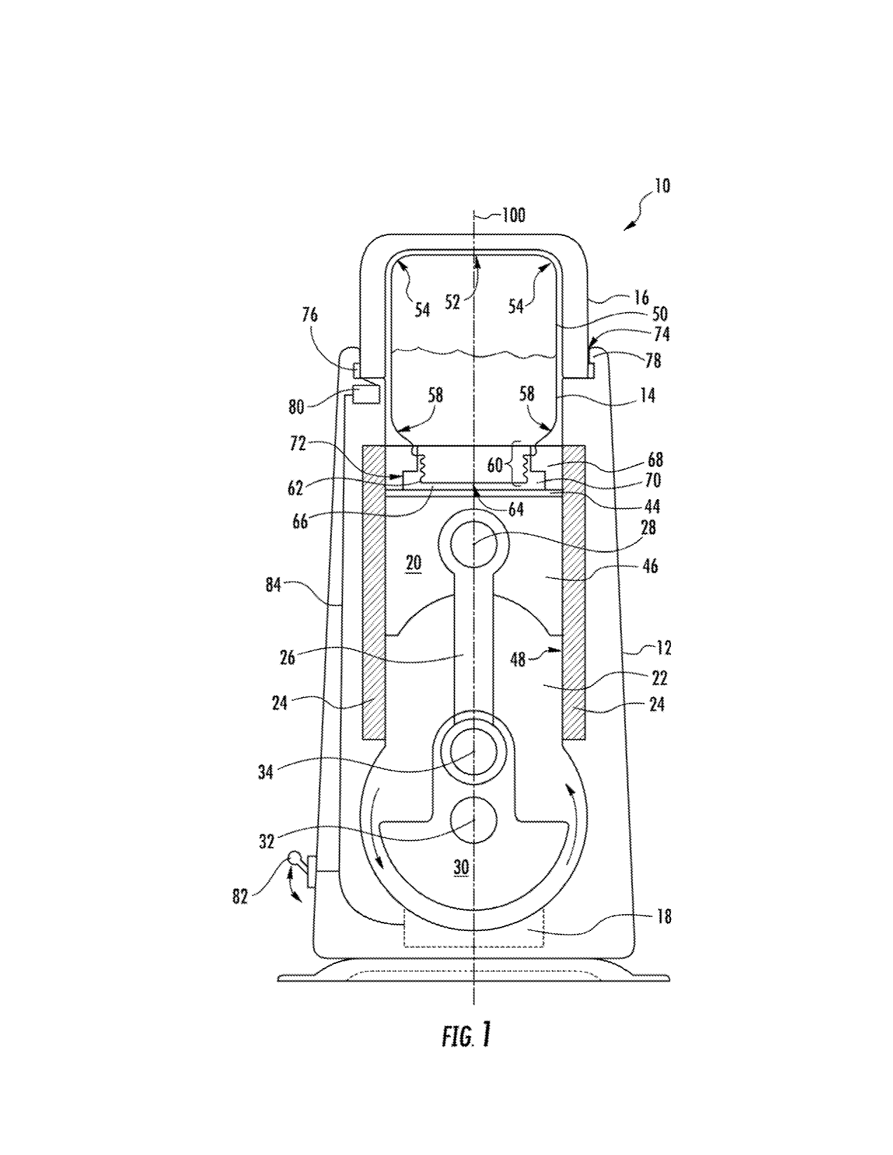

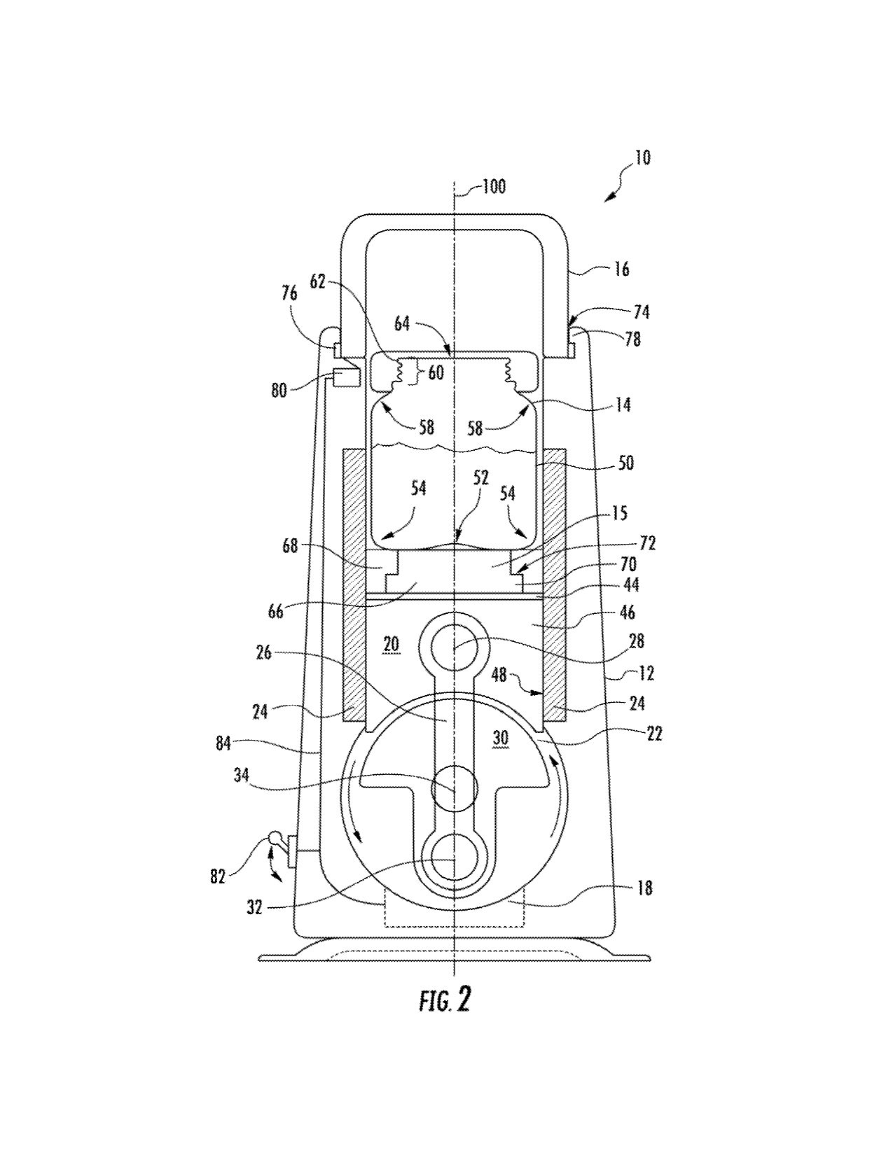

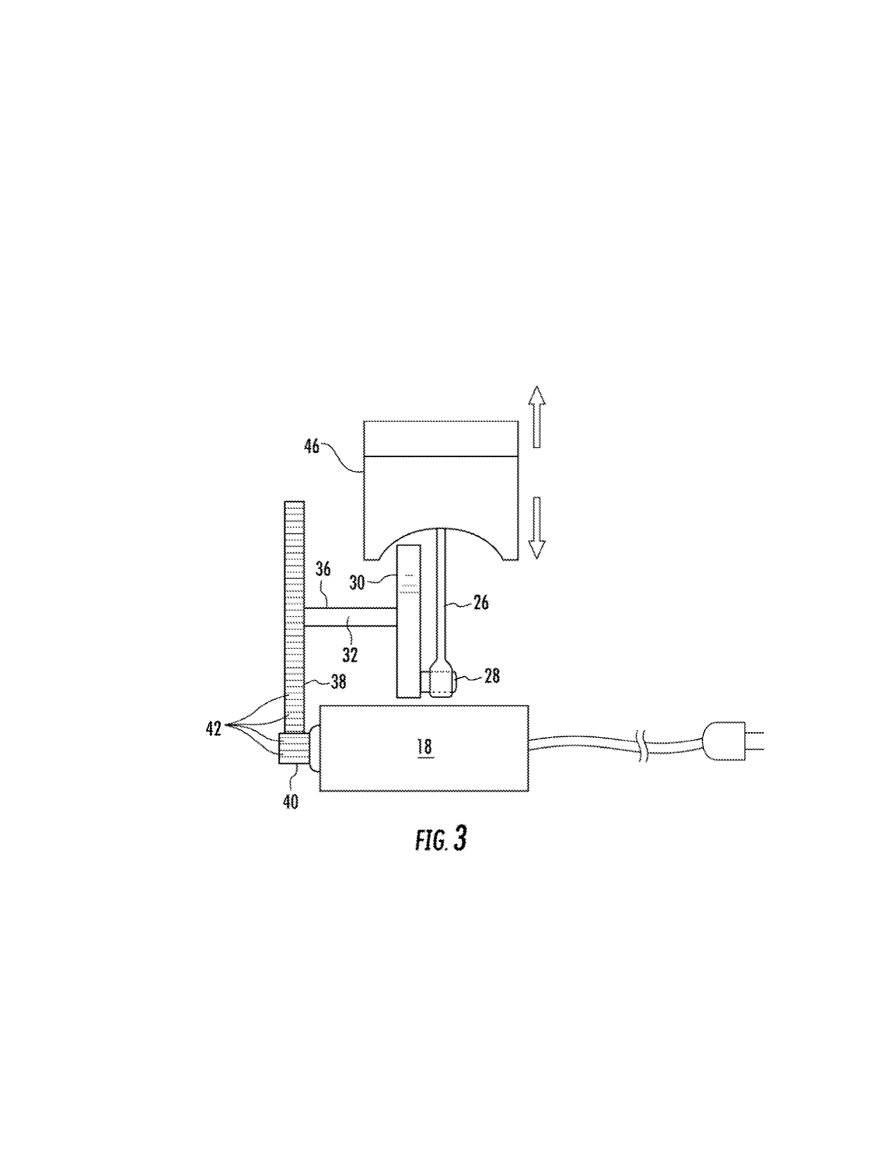

Reference is now made to FIGS. 1 and 2 in which there is illustrated front elevational views of the subject compact butter making appliance (hereinafter sometimes also referred to more simply as the “subject apparatus” or “butter maker”), designated generally by reference numeral 10, and depicting a piston at the apex of a downstroke and an upstroke, respectively. The subject apparatus is generally bullet-shaped and comprised of three primary components, namely a drive housing 12, a churning vessel 14, and a safety cover 16, each of which are more fully described below in seriatim.

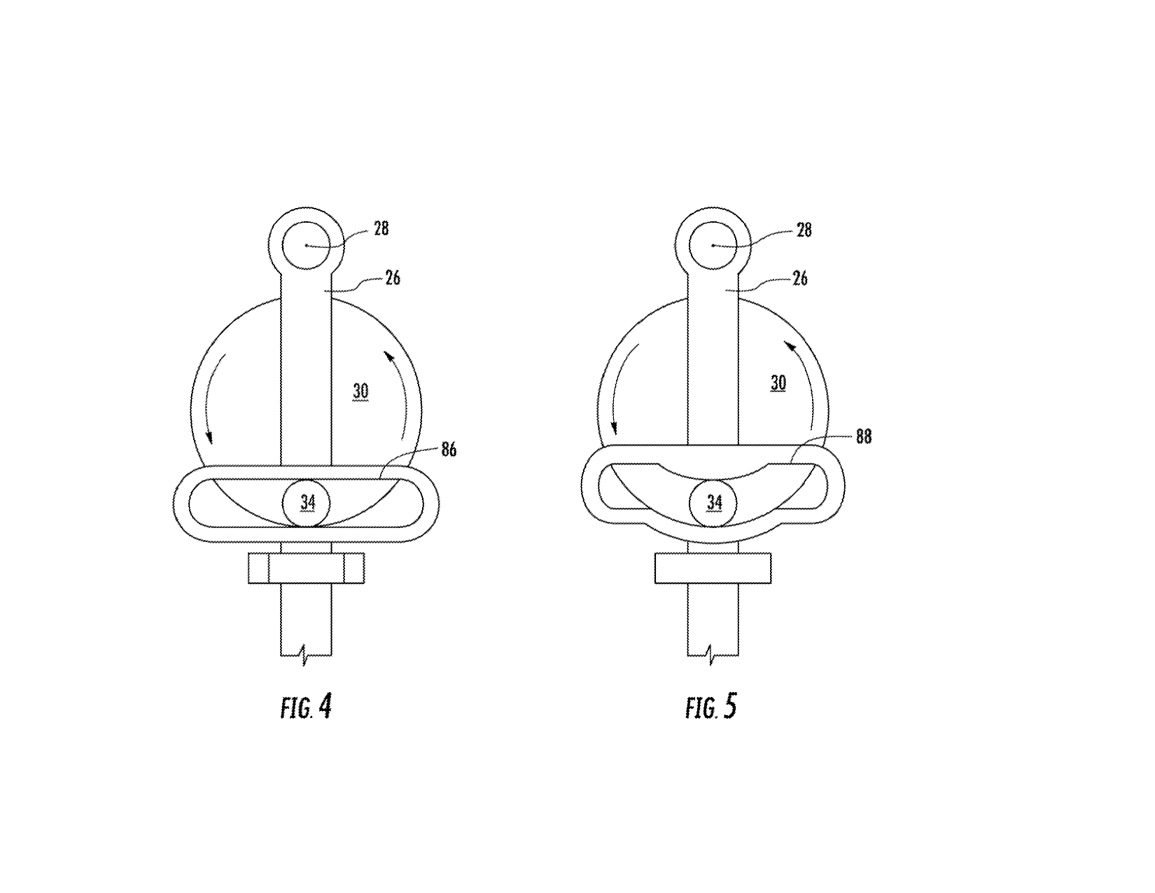

Housing 12 houses the working components of the apparatus including a motor 18, and a reciprocating drive assembly comprising a piston 20 slidably mounted within cylinder bore 22 of cylinder 24 which in turn is mounted to or integrally formed with the housing wall 24, a connecting rod 26 pivotally mounted at one end to piston 20 via piston pin 28 and at its opposite end to crank throw 30 of rotatable crankshaft 32 via crank pin 34. As best observed upon reference to FIG. 4, the proximal end 36 of crankshaft 32 is fixedly mounted to a geared flywheel 38 which acts to reduce the pulsation characteristic of the two-stroke piston cycle. Flywheel 38 is in operable engagement with rotary shaft 40 of motor 18 via interconnecting teeth 42. As should be readily understood, crankshaft 32 translates rotary motion of motor shaft 40 into reciprocating linear piston motion. A torsional or vibrational damper may be connected to the distal end of the crankshaft (not shown). Piston 20 includes a piston head 44 mounted to or integrally formed with piston skirt 46 which is the main body of the piston and which comes into sliding engagement with the interior surface 48 of the cylinder wall. The reciprocating drive assembly may further include any fixtures, couplers, attachments, conduits, ports or other components needed for translating rotary motion of motor shaft 40 into the desired reciprocating linear piston motion. Materials of construction for the subject gears can be metal or plastic. Gears are made from a wide variety of materials with many different properties. Factors such as design life, power transmission requirements, noise and heat generation, and presence of corrosive elements contribute to optimization of gear material. Metal choices include aluminum, brass, bronze, cast iron, steel, hardened steel, and stainless steel. Plastic choices include acetal, Delrin, nylon, and polycarbonate. Ground teeth provide smoother, higher-precision tooth form. Combination gears can have plastic teeth with metal inserts.

Churning vessel 14 is comprised of an open-ended, generally cylindrical shaped body 50 preferably having a flat or slightly concave bottom 52 with interior tapered shoulders 54 therebetween. The open end of churning vessel 14 preferably but not essentially also includes interior tapered shoulders 58 terminating in neck portion 60 having a perimeter edge 62 defining an opening 64 through which cream may be added and the products of churning may be removed. Body 50 of churning vessel 14 is diametrically smaller than the diameter of cylinder bore 46 to freely move therein in a reciprocating manner along axis 100 without contacting surface 48 of cylinder 24. Churning vessel 14 is further sized to prepare an amount of butter used by a typical family over one or more days or a week or two, or for entertaining. In one embodiment, churning vessel 14 may be a common Mason jar or other glass jar, which are both ideal for storage of the butter after it is produced. Alternatively, churning vessel may be constructed of plastic, stainless steel, Teflon, or any other substance from which butter or dairy products can be removed readily and are otherwise safe for use with food products. Preferably, churning vessel 14 is constructed of a transparent or translucent material to permit visualization of its contents during the churning process.

Churning vessel 14 is adapted to removably receive a lid 66 in a secure manner. For example, neck portion 60 and lid 66 may be reciprocally threaded for this purpose. Alternative or additional means of secure attachment, well known to those skilled in the art, may also be employed.

Piston head 44 is adapted with vessel retention means sized, shaped and configured to lockingly receive churning vessel 14. In a first embodiment (FIG. 1), lid 66 of churning vessel 14 is modified for retention within vessel retention means. For example, vessel retention means may be comprised of an annulus 68 having an inner diameter and thickness sized for frictional engagement with the circumferential wall of lid 66 when received therein. Lid 66 is further provided with a plurality of lateral (exterior) locking members 70, as generally shown in FIGS. 1 and 2, for locking engagement under locking rim 72 preventing unintentional displacement of churning vessel 14 from piston head 44. The locking members 70 are adapted to operatively lock together with vessel retention means of the piston drive assembly. Advantageously, lid 66 reversibly mates with or engages annulus 68 by twisting and locking in place, preferably, with only about ⅛ of a revolution of twist. Here again, alternative or additional means of secure removable attachment of lid 66 to piston head 44, well known to those skilled in the art, may be employed. In another embodiment, the bottom closed end of churning vessel 14 includes a base 15 fixedly attached thereto or integrally formed therewith and having any of the above-described or mentioned means for providing locking engagement with the vessel retention means. This second embodiment, therefore, does not require inversion of churning vessel 14 when being mounted to the reciprocating drive assembly.

Safety cover 16 is generally dome-shaped and preferably constructed of a transparent or translucent material to permit visualization of churning vessel 14 and its contents during the churning process. Safety cover 16 may be constructed of plastic, tempered glass, or opaque materials such as stainless steel, Teflon, or suitable materials. The purpose of safety cover 16 is to shield users from the moving parts of the subject apparatus during operation, namely from the churning vessel as it rises and falls during its reciprocating movement along axis 100. Note that when piston head 44 reaches the apex of its upstroke (FIG. 1) at least a portion of churning vessel 14 is oriented above the opening of housing 12 such that it is accessible for grasping for purposes of mounting and dismounting from the churning vessel retention means. Safety cover 16 is sized and shaped to accommodate churning vessel 14 therein, without contact, when piston head 44 is oriented at the apex of its upstroke, which said orientation is the default position when the appliance is turned off. Safety cover 16 is seated in a slot, groove or channel 74 circumferentially located at the top of housing 12.

Channel 74 is adapted with safety cover retention means sized, shaped and configured to lockingly receive safety cover 16 therein. In a first embodiment (shown), safety cover 74 is provided with a plurality of lateral (exterior) locking members 76, as generally shown in FIGS. 1 and 2, for locking engagement under locking rim 78 preventing unintentional displacement of safety cover 16 from channel 74. Safety cover 16 reversibly mates with or engages channel 74 by twisting and locking in place, preferably, with only about ⅛ of a revolution of twist. Here again, alternative or additional means of secure removable attachment of safety cover 16 to housing 12, well known to those skilled in the art, may be employed.

A pressure switch 80 is in communication with channel 74 and is closed (i.e., opens the circuit) when safety cover 16 is mounted within channel 74. More specifically, pressure applied to switch 80 by the downward pressure of the safety cover closes the switch. In a preferred embodiment, contact between safety cover 16 and switch 74 only occurs when the former is fully locked within channel 74. A toggle switch 82 mounted to housing 12 is electrically connected between pressure switch 80 and motor 18 via insulated wiring 84 and includes “Hi”, “Off” and “Low” settings. Other forms of switches including digital switch panels may be employed in the alternative.

In order to create the smallest countertop footprint, the subject appliance 10 is constructed so as to be taller than it is wide, with piston 46 being driven along a vertical axis 100. As may be appreciated, however, little modification would be required to produce alternate embodiments where the appliance is wider than it is tall and the reciprocating action occurs along a horizontal axis. In order to stabilize the embodiment illustrated from unwanted lateral movement and/or from the possibility of being accidentally knocked over, a suction cup may be mounted to the bottom of housing 12 as shown. Such stability can also be provided or augmented by a flared bottom to housing 12, or with frictional or adhesive feet or pads that impede or prevent lateral movement of the. butter maker on a surface.

It should be appreciated that other means of creating the requisite linear reciprocating motion may also be employed, the above-described reciprocating drive assembly being merely illustrative. For example, the reciprocating drive of conventional reciprocating saw may be modified to achieve the necessary reciprocating linear action. Alternatively, and referring to FIG. 4, the end of connecting rod 26 opposite piston 44 may terminate in fixedly attached yoke 86 the linear slot of which is in slidable engagement with crank pin 34 in a manner well known to those skilled in the art. The slot is perpendicular to axis 100. Yoke 86, also known as a “Scotch yoke” is a mechanism for converting the rotational motion of crank shaft 32 into the desired reciprocating linear motion of piston 44 for agitation of the cream within churning vessel 14. More specifically, in both the embodiments illustrated in FIGS. 1 and 4, the reciprocating linear motion of churning vessel 14 will cause the cream to displace the surrounding air within the vessel and impact the floor 52 and lid 66 causing the membranes of the butterfat globules to rupture. Such a churning mechanism creates constant movement of the air and cream in the churning vessel causing entrapment of the former in the latter at a greater rate and to a greater extent than would occur by mere introduction of a dasher into the cream contained in a static vessel, even if introduced in a reciprocating linear fashion. It is believed that the rapid entrapment of air within the cream is responsible, at least partly, for the rapid conversion of the cream into butter (or inversion of the emulsion).

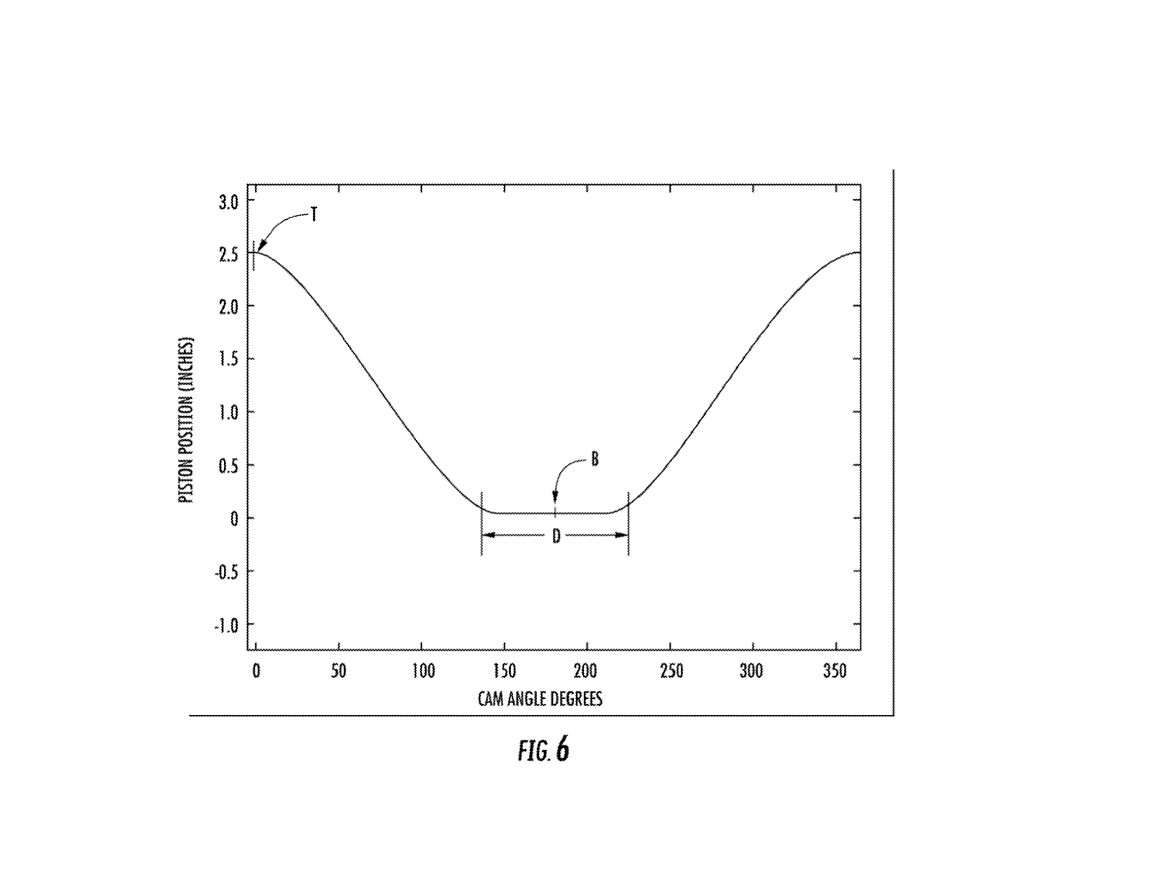

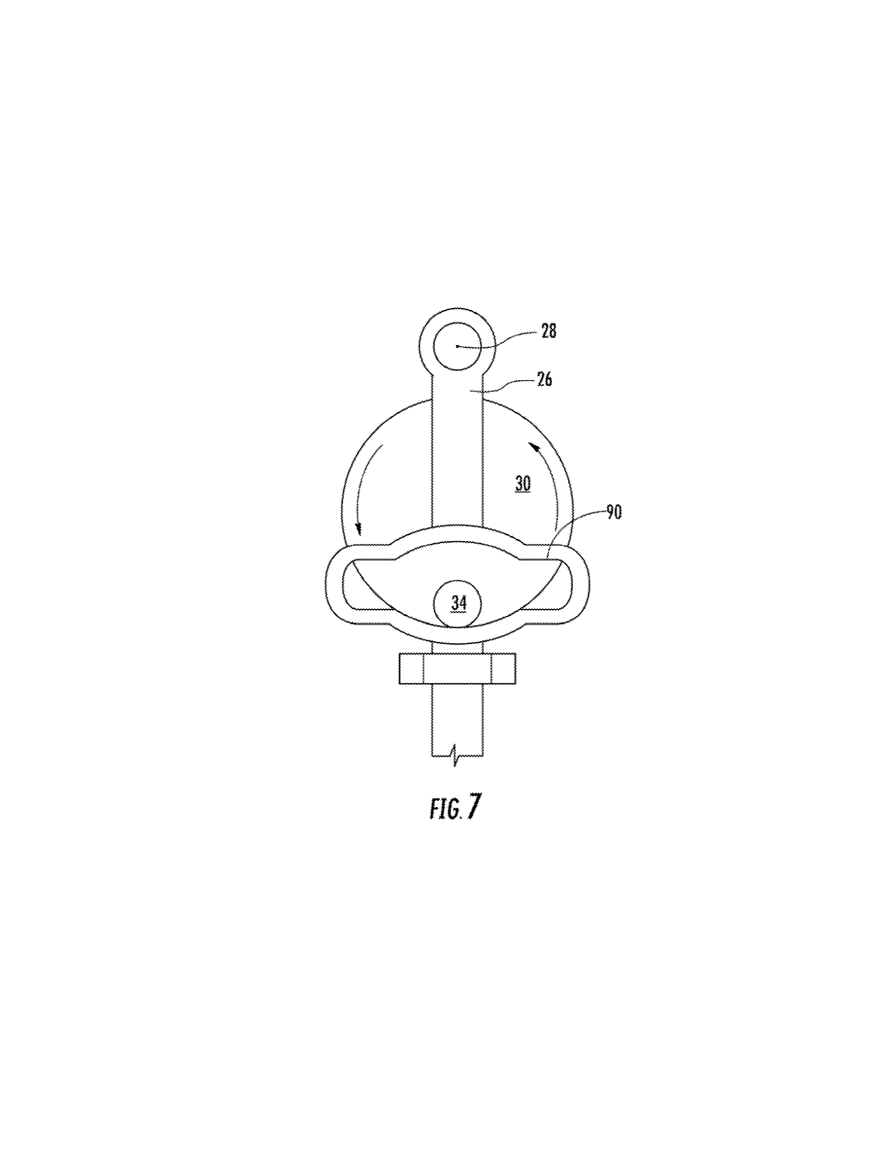

Advantageously, each piston cycle, which is comprised of an upstroke and a downstroke, may be interrupted with a momentary pause occurring at the apex of the upstroke and/or the downstroke. Referring to FIGS. 5 and 6, a singe pause or “dwell” is created in the piston cycle, in this case at the bottom of the stroke cycle, via first modified yoke 88. A portion of the slot of first modified yoke 88 is curved (i.e., radiused), as opposed to being purely linear as is the slot of yoke 86 (FIG. 4). The apex of the curve is located at the slot's midpoint and the curve conforms generally to the outermost radius of the crank throw 30 and, as readily appreciated by those skilled in the art, temporarily interrupts the movement of piston 44 as the crank pin 34 passes through the radiused portion of the slot. Referring to FIG. 6, the dwell, indicated by reference initial D, occurs at the bottom B of the stroke, cycle. By merely inverting the radius 180 degrees, the dwell can be made to occur at the top T of the stroke cycle. More particularly, when the radiused portion is concave relative to piston 20 (i.e., upwardly pointing) and , the dwell occurs at the apex of the upstroke and when the radiused portion is convex relative to piston 20 (i.e., downwardly pointing), the dwell occurs at the apex of the downstroke. By including both an upward and downward radius in the slot, as exists in the second modified yoke 90 of FIG. 7, a dwell will occur at both the top T and bottom B of the stroke cycle. By imparting a dwell into the top and/or bottom of each stroke cycle, the contents of the churning vessel has time to momentarily collect at either or both the lid end or bottom end of the churning vessel before being thrust against the opposite end. The effect is akin to throwing a water balloon against a wall causing the balloon to rupture and release its contents, as opposed to merely shaking a water balloon inside a closed vessel. The contents of the churning vessel 14 generally, and the fat globules in particular, therefore, experience a more abrupt and distinct shock as they impact the side of the churning vessel after each momentary dwell. Inclusion of at least one dwell in each cycle of reciprocating linear movement enhances the rate of conversion of cream into butter.

### Method of Use

Fill churning vessel 14 about ¼-½ full with 1-2 cups heavy whipping cream, or double cream (⅓ liter) (preferably without carrageenan or other stabilizers) and close with lid 66. Invert churning vessel 14 and secure to vessel retention means of reciprocating drive assembly. Attached safety cover x to housing 12 causing pressure switch x to close. Activate motor 18 to the High setting via toggle switch x located on the exterior of housing 18. The cream will go through the following stages: sloshy, frothy, soft whipped cream, firm whipped cream, coarse whipped cream. Then, suddenly, the cream will seize, its smooth shape will collapse, and the whirring will change to sloshing. The butter is now fine grained bits of butter in buttermilk, and a few seconds later, a glob of yellowish butter will separate from milky buttermilk. This process will take less than 30 seconds. Drain the buttermilk from churning vessel 14.

The butter may be eaten immediately—it has a light taste—though it will store better if washed and worked. Add ½ cup (100 mL) of ice-cold water, and churn further on the “Low” setting. Discard wash water and repeat until the wash water is clear. Work the butter to remove suspended water. Either place damp butter into a cool bowl and knead with a potato masher or two forks; or allow it to remain in the churning vessel and allow to tumble on the “Low” setting. Continue working, pouring out the water occasionally, until most of the water is removed. The butter is now ready. Put butter in a butter crock, ramekins, or roll in waxy freezer paper. Alternatively, the butter may be kept in the removable churning vessel 14 and refrigerated or set out at the table. The butter yield will be approximately half that by volume of the amount of cream charged to the churning vessel.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A butter making appliance adapted and configured for countertop operation comprising: a churning vessel having an open end through which cream may be introduced and butter may be withdrawn, said open end having a lid removably mountable thereto, said churning vessel being removably mountable to a motor-driven reciprocating drive housed within a housing, said drive being adapted and configured to drive said churning vessel in reciprocal motion, whereby the reciprocal motion of said churning vessel agitates cream contained therein causing it to convert to butter.

2. The butter making appliance of claim 1, further including a safety cover removably mounted to said housing for enclosing said churning vessel therein, whereby said drive is operable only when said safety lid is mounted to said housing.

3. The butter making appliance of claim 1, wherein said reciprocating drive is comprised of a piston slidably mounted within a cylinder bore of a cylinder, said cylinder being mounted within said housing, a connecting rod having a first end and a second end, said first end being pivotally mounted to a piston, said second end being pivotally mounted to a crank throw of a rotatable crankshaft, said crankshaft being in operable engagement with the rotary shaft of a motor, whereby said crankshaft translates rotary motion of said motor shaft into reciprocating linear piston motion.

4. The butter making appliance of claim 2, wherein said reciprocating drive is comprised of a piston slidably mounted within a cylinder bore of a cylinder, said cylinder being mounted within said housing, a connecting rod having a first end and a second end, said first end being pivotally mounted to said piston, said second end being pivotally mounted to a crank throw of a rotatable crankshaft, said crankshaft being in operable engagement with the rotary shaft of a motor, whereby said crankshaft translates rotary motion of said motor shaft into reciprocating linear piston motion.

5. The butter making appliance of claim 3, wherein said second end is fixedly mounted to a yoke having a linear slot perpendicular to the axis of reciprocating linear motion and in slidable engagement with a crank pin rotatably mounted to said crank throw, whereby said yoke, crank pin and crank throw convert the rotational motion of said crank shaft into reciprocating linear motion of said piston for agitation of cream charged to said churning vessel causing the cream to transform into butter.

6. The butter making appliance of claim 4, wherein said second end is fixedly mounted to a yoke having a linear slot perpendicular to the axis of reciprocating linear motion and in slidable engagement with a crank pin rotatably mounted to said crank throw, whereby said yoke, crank pin and crank throw convert the rotational motion of said crank shaft into reciprocating linear motion of said piston for agitation of cream charged to said churning vessel causing the cream to transform into butter.

7. The butter making appliance of claim 3, wherein said slot of said yoke includes at least one centrally disposed radiused portion selected from the group consisting of a concave radius and a convex radius for imparting at least one dwell in each piston stroke cycle of said reciprocating linear motion, whereby cream contained within said churning vessel is caused to momentarily collect in at least one end of said churning vessel during said at least one dwell and thereafter be abruptly cast against the opposite end of the churning vessel.

8. The butter making appliance of claim 4, wherein said slot of said yoke includes at least one centrally disposed radiused portion selected from the group consisting of a concave radius and a convex radius for imparting at least one dwell in each piston stroke cycle of said reciprocating linear motion, whereby cream contained within said churning vessel is caused to momentarily collect in at least one end of said churning vessel during said at least one dwell and thereafter be abruptly cast against the opposite end of the churning vessel.

9. The butter making appliance of claim 5, wherein said slot of said yoke includes at least one centrally disposed radiused portion selected from the group consisting of a concave radius and a convex radius for imparting at least one dwell in each piston stroke cycle of said reciprocating linear motion, whereby cream contained within said churning vessel is caused to momentarily collect in at least one end of said churning vessel during said at least one dwell and thereafter be abruptly cast against the opposite end of the churning vessel.

10. The butter making appliance of claim 6, wherein said slot of said yoke includes at least one centrally disposed radiused portion selected from the group consisting of a concave radius and a convex radius for imparting at least one dwell in each piston stroke cycle of said reciprocating linear motion, whereby cream contained within said churning vessel is caused to momentarily collect in at least one end of said churning vessel during said at least one dwell and thereafter be abruptly cast against the opposite end of the churning vessel.

11. The butter making appliance of claim 3, wherein said churning vessel is removably mountable to said piston in either a lid-to-piston or base-to-piston orientation.

12. The butter making appliance of claim 4, wherein said churning vessel is removably mountable to said piston in either a lid-to-piston or base-to-piston orientation.

13. The butter making appliance of claim 5, wherein said churning vessel is removably mountable to said piston in either a lid-to-piston or base-to-piston orientation.

14. The butter making appliance of claim 6, wherein said churning vessel is removably mountable to said piston in either a lid-to-piston or base-to-piston orientation.

15. The butter making appliance of claim 7, wherein said churning vessel is removably mountable to said piston in either a lid-to-piston or base-to-piston orientation.

16. The butter making appliance of claim 8, wherein said churning vessel is removably mountable to said piston in either a lid-to-piston or base-to-piston orientation.

17. The butter making appliance of claim 9, wherein said churning vessel is removably mountable to said piston in either a lid-to-piston or base-to-piston orientation.

18. The butter making appliance of claim 10, wherein said churning vessel is removably mountable to said piston in either a lid-to-piston or base-to-piston orientation.
